(19) United States
(12) Patent Application Publication
(10) Pub. No.: US 2026/0247345 A1
(43) Pub. Date: Aug. 20, 2026

(54) METHOD FOR MANAGING REACHABILITY OF A USER EQUIPMENT IN A NON-TERRESTRIAL NETWORK

(71) Applicant: GOOGLE LLC, Mountain View, CA (US)

(72) Inventors: Chih-Hsiang Wu, Taoyuan City (TW); Sang Min Park, Mountain View, CA (US)

(21) Appl. No.: 19/161,040

(22) PCT Filed: Feb. 28, 2024
(86) PCT No.: PCT/US2024/017655

§ 371 Date: Aug. 29, 2025

(51) Int. Cl. H04W 68/02; H04B 7/185

(52) U.S. Cl. CPC H04W 68/02; H04B 7/18513

(57) ABSTRACT

A user equipment (UE) communicating with a non-terrestrial network (NTN) node can implement a method for managing paging for the UE from a core network (CN). The method includes: (i) receiving, from the CN and at the UE, a downlink message including NTN time information associated with reachability; (ii) starting, at the UE, a timer with a time duration based on the NTN time information; and (iii) suspending, at the UE, monitoring paging for the UE while the timer is running.

### CROSS-REFERENCE TO RELATED APPLICATIONS

This application claims priority to and the benefit of the filing date of provisional U.S. patent application Ser. No. 63/488,451 entitled “METHOD FOR MANAGING REACHABILITY OF A USER EQUIPMENT IN A NON-TERRESTRIAL NETWORK,” filed on Mar. 3, 2023. The entire contents of the provisional application are hereby expressly incorporated herein by reference.

### FIELD OF THE DISCLOSURE

This disclosure relates generally to methods, devices, and articles in wireless communication systems, such as 3GPP communication systems.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station and does not store a UE access stratum (AS) context; the RRC_CONNECTED state, in which the UE has an active radio connection with the base station; and the RRC_INACTIVE state, in which a UE can more quickly transition back to the RRC_CONNECTED state due to Radio Access Network (RAN)-level base station coordination and RAN-paging procedures.

The 5G technology relies primarily on legacy terrestrial networks. However, the 3rd Generation Partnership Project (3GPP) organization has proposed to extend 5G communications to non-terrestrial networks (NTNs) with 5G new radio (NR) technologies, or with the Long-Term-Evolution (LTE) technologies tailored for the Narrowband Internet-of-Thing (NB-IOT) or the enhanced Machine Type Communication (eMTC) scenarios. In an NTN, an RF transceiver is mounted on a satellite, an unmanned aircraft systems (UAS) also referred to as drone, balloon, plane, or another suitable apparatus. For simplicity, the discussion below refers to all such apparatus as satellites. In addition to satellites, an NTN can include the sat-gateways that connect the Non-Terrestrial Network to a public data network, feeder links between sat-gateways and satellites, service links between satellites, and inter-satellite links (ISL) when satellites form constellations.

A satellite can belong to one of several types based on altitude, orbit, and beam footprint size. The types include Low-Earth Orbit (LEO) satellite, Medium-Earth Orbit (MEO) satellite, Geostationary Earth Orbit (GEO) satellite, UAS platform (including High Altitude Platform Station (HAPS)), and High Elliptical Orbit (HEO) satellite. GEO satellites are also known as the Geosynchronous Orbit (GSO) satellites, and LEO/MEO satellites are also known as non-GSO (NGSO) satellites.

A GSO satellite can communicate with one or more sat-gateways deployed over a satellite targeted coverage area (e.g., a region, country, continent, etc.). A non-GSO satellite at different times can communicate with one or several serving sat-gateways. An NTN is designed to ensure service and feeder link continuity between successive serving sat-gateways, with sufficient time duration to proceed with mobility anchoring and hand-over procedures.

A satellite can support a transparent or a regenerative (with on board processing) payload, and typically generates several beams for a given service area bounded by the field of view. The footprints of the beams typically have an elliptic shape and depend on the on-board antenna configuration and the elevation angle. For a transparent payload implementation, a satellite can apply RF filtering and/or frequency conversion and amplification, and refrain from changing the waveform signal. For a regenerative payload implementation, a satellite can apply RF filtering, frequency conversion and amplification, demodulation and decoding, routing, and/or coding/modulation. This approach is effectively equivalent to implementing most of the functions of a base station, e.g., a gNB or an eNB.

NB-IOT and eMTC technologies are expected to be particularly suitable for IoT devices operating in remote areas with limited or no terrestrial connectivity. Such IoT devices can be used in a variety of industries including for example transportation (maritime, road, rail, air) and logistics; solar, oil, and gas harvesting; utilities; farming; environmental monitoring; and mining. However, to ensure the required loT connectivity, deployment of these technologies requires satellite connectivity to provide coverage beyond terrestrial deployments. Satellite NB-IoT or eMTC is defined in a complementary manner to terrestrial deployments.

After the UE registers with a core network (CN), the CN manages UE reachability of the UE (e.g., as described in 3GPP TS 24.501 for 5G System (5GS) and 3GPP TS 24.301 for Evolved Packet System (EPS)). When the UE releases a NAS signaling connection, or enters an idle state/mode (e.g., CM-IDLE, EMM-IDLE, or 5GMM-IDLE), then both the UE and a CN node starts timers. The CN node starts a mobile reachable timer for the UE while the UE starts a periodic tracking area update (TAU) timer with a value smaller than the value of the mobile reachable timer. For 5GS, the CN node is an Access and Mobility Management Function (AMF) and the periodic TAU timer is a periodic registration timer (e.g., a NAS timer T3512). For EPS, the CN node is a Mobility Management Entity (MME) and the periodic TAU timer is a NAS timer (e.g., NAS timer T3412). While the mobile reachable timer is running, the CN node considers the UE as reachable, so the network sends paging when it needs to retrieve the NAS signaling connection (e.g., has Mobile Terminated (MT) data to be transferred to the UE, or MT signaling pending). When the periodic TAU timer expires in the UE, the UE performs a periodic TAU (tracking area update) (EPS) or periodic registration update procedure with the CN node. In response, the CN node stops the mobile reachable timer and changes the UE Connection Management (CM) status to a connected state/mode.

If the UE in the idle state/mode has not accessed the CN node until the mobile reachable timer expires, then the CN node starts an implicit de-registration timer. The implicit de-registration timer might have a similar value as the mobile reachable timer. While the implicit de-registration timer is running, the CN node considers the UE as non-reachable, but still registered, and does not page the UE for a mobile terminating signaling, data, or voice call. If the CN node receives a message from the UE while the implicit de-registration timer is running, the CN node stops the implicit de-registration timer. If the implicit de-registration timer expires, then the CN node will de-register the UE implicitly and considers the UE as not registered.

The UE communicates with the CN node via an NTN (i.e., satellite(s)). In some scenarios, the UE may not always be in coverage of the NTN. For example, a UE with only satellite access capability can be in coverage of an NTN for 20 minutes every 10 hours (e.g., as depicted in S2-2109199). Such scenarios are identified as discontinuous coverage scenarios and cause problems with managing the UE reachability as described below.

When the UE moves out of NTN coverage (i.e., the UE is in discontinuous coverage), the CN node does not reach the UE until the UE enters NTN coverage again. While the mobile reachable timer is running for the UE, the CN node considers the UE as reachable and attempts to page the UE for mobile terminating signaling, data, or voice call via a base station and NTN. Because the UE is in discontinuous coverage, the CN node fails to page the UE, which wastes resources and power. When the mobile reachable timer expires while the UE is in discontinuous coverage, the CN node considers the UE as unreachable. Later in time, if the UE returns to NTN coverage but does not perform any initial NAS procedure (e.g., a service request procedure, a tracking area update procedure (for EPS), or a registration procedure (for 5GS)), the CN node continues to consider the UE to be unreachable, and does attempt to page the UE even if there is MT signaling or MT data pending. Further, when the UE transmits a request message to the CN node (e.g., to perform a tracking area update procedure after the UE returns to NTN coverage), the CN node may transmit a reject message to reject the request message. Thus, the reject message causes the UE to perform a registration procedure or attach procedure with the CN node to re-register with the CN node, which wastes battery power of the UE.

### SUMMARY

A UE maintains a non-terrestrial network (NTN) reachability timer for managing paging during discontinuous coverage when communicating with an NTN node. The UE receives, from the CN, a downlink message including NTN time information associated with reachability. The UE then starts, using the NTN time information, a timer indicating how long the UE will be out of coverage. The UE then suspends monitoring paging for the UE while the timer is running.

A CN node maintains a non-terrestrial network (NTN) reachability timer for managing paging during discontinuous coverage when communicating with a UE. The CN node transmits, to the UE, a downlink message including NTN time information associated with reachability.

The CN node then starts, using the NTN time information, a timer indicating how long the UE will be out of coverage. The CN node then suspends paging for the UE while the timer is running.

### BRIEF DESCRIPTION OF THE DRAWINGS

FIG. 1 is a block diagram of an example wireless communication system in which a user device and a base station of this disclosure can implement the paging techniques of this disclosure;

FIG. 2 is a block diagram of an example protocol stack according to which the UE of FIG. 1 communicates with base stations;

FIG. 3A is a block diagram of an example NTN node with transparent payload implementation;

FIG. 3B is a block diagram of an example NTN node with transparent payload implementation, in which a base station connects to multiple satellites via the same sat-gateway;

FIG. 4A illustrates an exemplary user plane protocol stack for use with the architecture of FIG. 3A;

FIG. 4B illustrates an exemplary control plane protocol stack for use with the architecture of FIG. 3A;

FIG. 5 illustrates an example scenario in which a UE has satellite coverage during certain time periods separated by intervals of non-coverage;

FIG. 6 is a messaging diagram of an example scenario in which an MME layer of a CN provides unreachable timer information to a UE to start a timer, during which the UE and the MME will refrain from paging or otherwise attempting to communicate, which can be implemented in the system of FIG. 1;

FIG. 7A is a messaging diagram of an example scenario similar to the scenario of FIG. 6, but in which an AMF layer of the CN provides the unreachable timer information as a configuration command, which can be implemented in the system of FIG. 1;

FIG. 7B is a messaging diagram of an example scenario similar to the scenario of FIG. 7A, but in which the AMF transmits the unreachable timer information as part of a registration procedure, which can be implemented in the system of FIG. 1;

FIG. 8A illustrates an example scenario with NTN unreachable coverage, in which an MME or AMF layer of a CN refrains from paging a UE while an unreachable timer is running;

FIG. 8B illustrates an example scenario similar to FIG. 8A, but in which a mobile reachable timer is simultaneously running and the unreachable timer causes the CN and the UE to refrain from paging and/or other such communication;

FIG. 9A is a flow diagram of an example method, implemented in a UE, for receiving unreachable time information and starting an unreachable timer, during which the UE refrains from accessing the NTN;

FIG. 9B is a flow diagram of an example method, implemented in a UE and similar to the method of FIG. 9A, but in which the UE disables one or more idle mode tasks while the unreachable timer is running;

FIG. 9C is a flow diagram of an example method, implemented in a UE and similar to the method of FIG. 9A, but in which the UE enters a lower power mode while the unreachable timer is running;

FIG. 10 is a flow diagram of an example method, implemented in a UE, for determining unreachable time information based on information received in broadcast signaling when the UE does not receive the unreachable time information;

FIG. 11 is a flow diagram of an example method, implemented in a CN, for transmitting unreachable time information to a UE, starting an unreachable timer, and refraining from paging the UE while the unreachable timer is running;

FIG. 12 is a flow diagram of an example method for managing paging for a UE, implemented in the UE; and

FIG. 13 is a flow diagram of an example method for managing paging for a UE, implemented in a CN.

### DETAILED DESCRIPTION OF THE DRAWINGS

As discussed in more detail below, a user equipment (UE) and/or a network node of a radio access network (RAN) can use the techniques of this disclosure for managing early data communication and transitioning a UE between states of a protocol for controlling radio resources between the UE and the RAN.

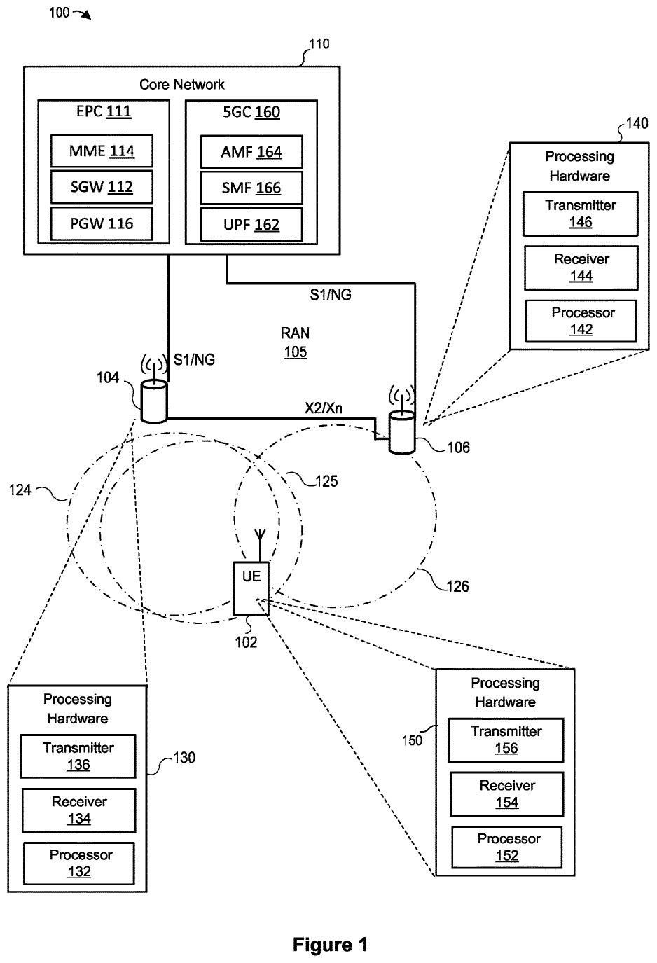

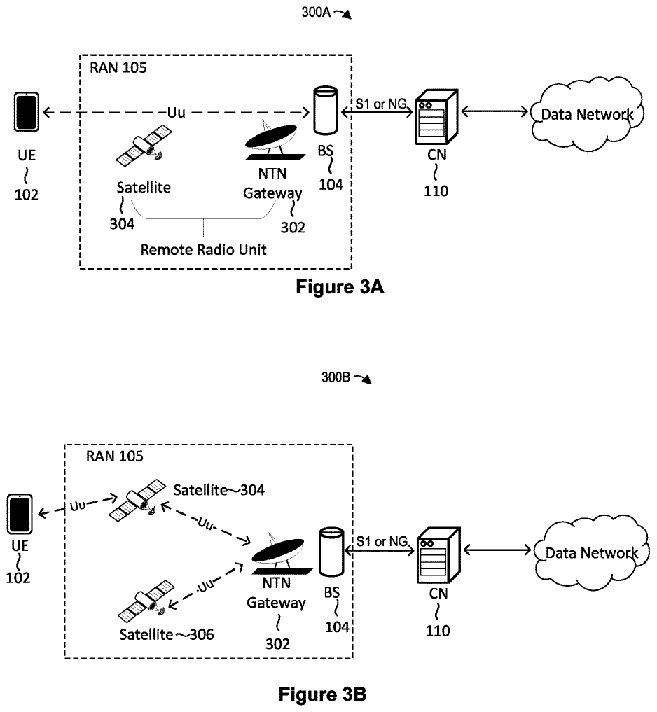

Referring first to FIG. 1, an example wireless communication system 100 includes a UE 102, a base station 104, a base station 106, and a core network (CN) 110. The base stations 104 and 106 can operate in a RAN 105 connected to the core network (CN) 110 and other base station components, such as satellites, as will be described with reference to FIGS. 3A and 3B below. The CN 110 can be implemented as an evolved packet core (EPC) 111 or a fifth generation (5G) core (5GC) 160, for example. The CN 110 can also be implemented as a sixth generation (6G) core and future evolutions.

The base station 104 covers a cell 124, and the base station 106 covers a cell 126. If the base station 104 is a gNB, the cell 124 is an NR cell. If the base station 104 is an ng-eNB or eNB, the cell 124 is an evolved universal terrestrial radio access (E-UTRA) cell. Similarly, if the base station 106 is a gNB, the cell 126 is an NR cell, and if the base station 106 is an ng-eNB or eNB, the cell 126 is an E-UTRA cell. The cells 124 and 126 can be in the same Radio Access Network Notification Areas (RNA) or different RNAs. In general, the RAN 105 can include any number of terrestrial and non-terrestrial base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of terrestrial and/or non-terrestrial base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

The base station 104 is equipped with a transceiver and processing hardware 130 that can include one or more general-purpose processors (c.g., CPUs) and a non-transitory computer-readable memory storing instructions that the one or more general-purpose processors execute.

Additionally or alternatively, the processing hardware 130 can include special-purpose processing units. The processing hardware 130 in an example implementation includes a processor 132 to process data that the base station 104 will transmit in the downlink direction, or process data received by the base station 104 in the uplink direction. The processing hardware 130 can also include a transmitter 136 configured to transmit data in the downlink direction. The processing hardware further can include a receiver 134 configured to receive data in the uplink direction. The processing hardware further can include an RRC controller 138 to implement procedures and messaging at the RRC sublayer of the protocol communication stack. The base station 106 can include generally similar components. In particular, components 140, 142, 144,146, and 148 of the base station 106 can be similar to the components 130, 132, 134, 136, and 138 respectively.

The UE 102 is equipped with a transceiver and processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transmitter 156 configured to transmit data in the downlink direction. The processing hardware further can include a receiver 154 configured to receive data in the uplink direction. The processing hardware further can include an RRC controller 158 to implement procedures and messaging at the RRC sublayer of the protocol communication stack.

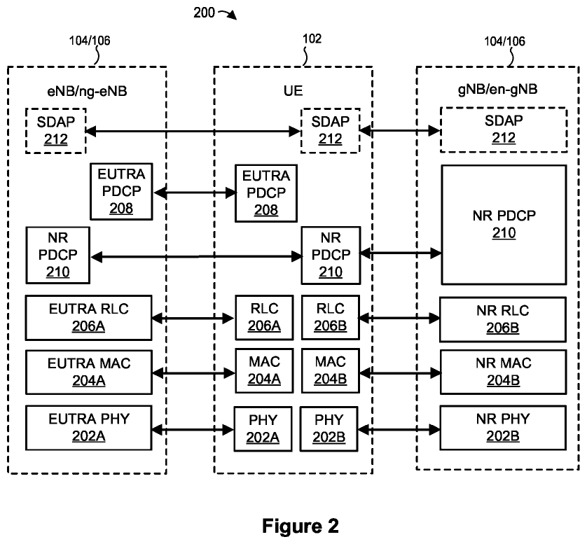

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 3A illustrates a certain type of NTN deployment referred to as transparent payload architecture, which involves a satellite gateway 302 and a “transparent” satellite 304 for extending the range of the Uu interface. The satellite 304 implements a frequency conversion and a Radio Frequency (RF) amplifier in both the uplink and downlink directions. The satellite function is similar to that of an analogue RF repeater. As a result, the satellite 304 repeats the Uu radio interface from the feeder link (between the NTN gateway and the satellite) to the service link (between the satellite and the UE) in the downlink direction and vice versa in the uplink direction. The Satellite Radio Interface (SRI) on the feeder link is the Uu, and the NTN gateway 302 supports all necessary functions to forward the signal of the Uu interface. The NTN gateway 302 can be placed at the same site as the base station (e.g., eNB, gNB) 104 location, or be connected to the base station 104 at a distance via a wired link. It is also possible to connect more than one NTN gateway to a base station. Different transparent satellites may be connected to the same base station on the ground, via the same NTN gateway, or via different NTN gateways.

FIG. 3B illustrates the implementation in which two different satellites (304 and 306) connect to the same base station 104 via the same NTN gateway 302, and these two satellites (304 and 306) are covering the Earth surface using two different Physical Cell IDs (PCIs).

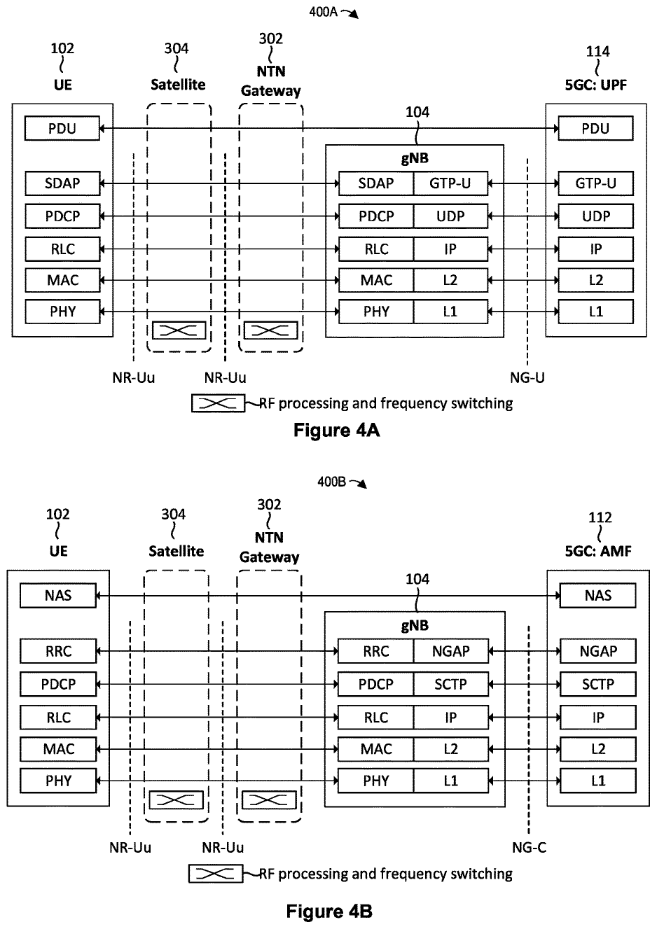

Next, FIG. 4A illustrates an NTN user-plane protocol stack involving the UE 102, the satellite 304, the NTN gateway 302, the base station 104, and the EPC S-GW 112 (or 5GC SMF 166). The NTN user-plane protocol stack is similar to that of the terrestrial network (TN), except that the configuration of FIG. 4A illustrates two additional nodes, the satellite 304 and the NTN gateway 302, operating in the middle of the Uu interface. Similarly, the NTN control plane protocol stack illustrated of FIG. 4B is also generally analogous to that of the terrestrial network counterpart shown in FIG. 2B.

Referring generally to FIGS. 1-4B, NTN supports at least three types of service links NTN, described in terms of satellite movement patterns: (i) Earth-fixed: provisioned by beam(s) continuously covering the same geographical areas all the time (e.g., the case of GEO/GSO satellites); (ii) Quasi-Earth-fixed: provisioned by beam(s) covering one geographic area for a limited period and a different geographic area during another period (e.g., the case of LEO/MEO satellites capable of using steerable beams); and (iii) Earth-moving: provisioned by beam(s) whose coverage area slides over the Earth surface (e.g., the case of LEO/MEO satellites using fixed or non-steerable beams).

With LEO/MEO satellites, a base station can provide either quasi-Earth-fixed cell coverage or Earth-moving cell coverage. With GEO satellites, the base station can provide Earth fixed cell coverage.

Although the transparent payload architecture illustrated in FIGS. 3A and 3B is the current focus of the 3GPP development, the regenerative payload architecture that places some of the base station functions on the satellite is also a possible NTN deployment in the future. In such an architecture, the Uu only exists between the satellite and the UE. In general, the techniques of this disclosure can apply to the transparent payload architecture as well as the regenerative payload architecture.

Again referring generally to FIGS. 1-4A, the UE 102 operating in a certain cell must be able to detect reference signals from the neighboring cells and measure the strength of the reference signals to be able to switch to a qualified neighboring cell when needed (i.e., when the serving cell is no longer able to serve the UE due to poor signal reachability), or in order to add a new Carrier Component (CC). The reference signal a base station can use for this purpose with the NR radio interface is the synchronization signal (SS) and physical broadcast channel (PBCH) block, abbreviated as SSB. Unlike the LTE radio interface in which a base station transmits SS every 5 ms, 5G NR allows each base station to transmit the SSB burst with different time patterns, with the longest periodicity of up to 160 ms. This allows the network to configure the SSB transmission in a more dynamic manner dependent on the actual usage and channel condition.

This approach helps to avoid unnecessary measurements and reduce the power consumption of a UE. However, this flexibility comes at the cost of the additional signaling required to inform the UE when to perform measurement on a measurement target. Without the additional signaling, the UE would need to assume the worst-case scenario (in the implementation above, the 5 ms periodicity) to determine when to measure the target. As a result, the UE achieves no power saving gain. This additional signaling in 5G NR is known as “SSB based measurement timing configuration (SMTC),” which contains a periodicity setting ranging from 5 ms to 160 ms and a duration setting ranging from 1 ms to 5 ms.

The network does not need to align the SMTC periodicity setting with the actual SSB burst periodicity. For instance, the SMTC periodicity can be set to a value larger than the SSB burst periodicity to further reduce the power consumption of the UE. In addition to the periodicity and duration settings, the SMTC also indicates a timing offset to inform the UE of the exact subframe where the UE should start monitoring the SSB burst, which occurs repeatedly according to the periodicity setting. A base station can signal the periodicity and the timing offset settings together, in one measurement object, as a single parameter periodicityAndOffset.

There can be a relatively small timing difference between the timing of the Primary Cell (PCell) and the timing of the measurement target, in part due to the propagation delay difference. A terrestrial network can ignore this small timing difference, as the propagation delay difference is small and hence requires no adjustment in the timing offset setting. Accordingly, 3GPP TS 38.331(v 16.6.0 ) currently specifies only one timing offset for the measurement object configuration. For a non-terrestrial network, however, the propagation delay between a satellite and a UE could be longer (e.g., up to 25.77 ms), and the variance for different satellites can be significant (e.g., between 8 ms and 25.77 ms).

A UE and/or a base station can use an individual timing offset setting associated with each respective measurement target (i.e., a satellite) configured in a measurement object. This approach can result in multiple timing offsets settings or even multiple SMTCs configured in one measurement object. Although a measurement object can support two SMTCs, these SMTCs currently must share the same timing offset setting and hence cannot address the propagation delay issue in an NTN discussed above.

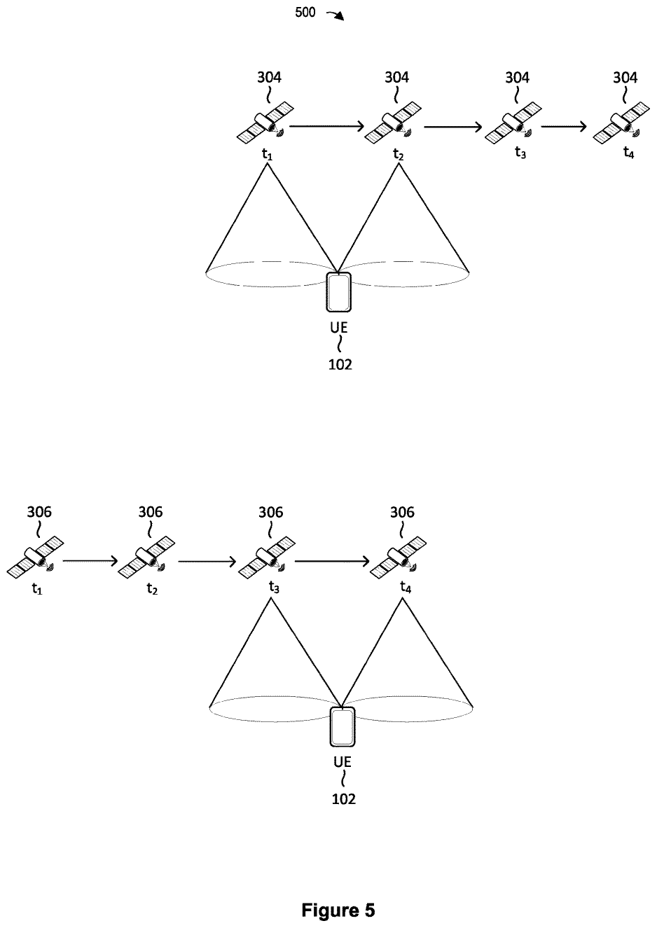

FIG. 5 illustrates an example scenario 500 in which the UE 102 may experience discontinuous coverage from an NTN due, for example, to a sparse satellite constellation deployment. In the scenario 500, the UE 102 is within a first coverage zone 314 served by the LEO satellite 304 from t1 to t2, and within a second coverage zone 316 served by another LEO satellite 306 from t3 to t4. In the period between t2 to t3, however, the UE 102 is not served by any satellite or any terrestrial base station, and therefore is out of a coverage zone for the NTN nodes. Typically, when a UE 102 loses coverage by a serving cell, the UE 102 starts searching for other cells and then camps on a suitable cell. However, in the example illustrated in FIG. 5, even if the UE 102 starts searching for other cells immediately after t2, the UE 102 does not find a cell. Moreover, depending on the implementation, the cell search lasts for a long time, as the time period between t2 to t3 can vary from tens of minutes to hours. Therefore, the cell search causes extra, unnecessary power consumption in the UE 102.

To reduce power consumption at the UE in such scenarios as the one depicted in FIG. 5, the UE 102 may not be required to perform the cell search and can deactivate the Access Stratum (AS) functions during the period when the UE is not within the area of coverage of a satellite. In some implementations, the UE 102 has knowledge of when the UE 102 will be outside the area of coverage, and when the UE 102 will be within an area of coverage again, in order to reactivate the cell search or AS functions before the UE 102 falls into the coverage of another NTN cell. For example, the ephemeris information broadcast in the system information provides the constellation and trajectory or movement information of nearby satellites (e.g., the serving and the neighboring satellites), which helps the UE 102 to estimate when the UE 102 will be within or outside the NTN coverage. In addition to the ephemeris information, the UE 102 may use other information to estimate coverage of a NTN cell more precisely.

In some scenarios, the UE 102 in a connected state (e.g., RRC_CONNECTED state) communicates with a RAN (e.g., RAN 105) via the satellite 304 and detects radio link failure on the service link with the satellite 304 because the UE 102 is out of coverage of the satellite 304 (e.g., in the period between t2 to t3). In response to the radio link failure, the UE 102 initiates an RRC connection reestablishment procedure (e.g., in accordance with 3GPP specification 38.331).

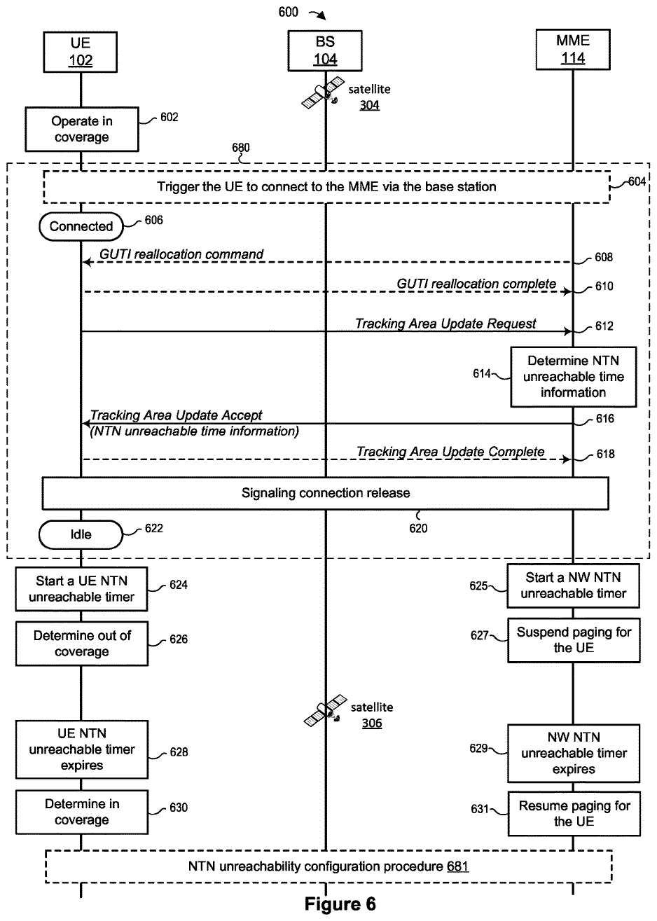

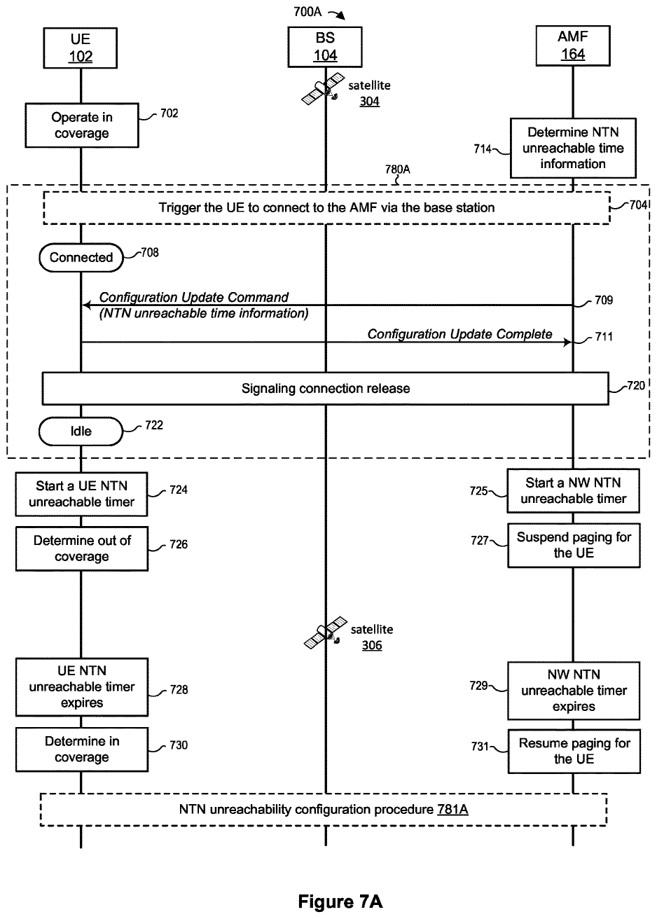

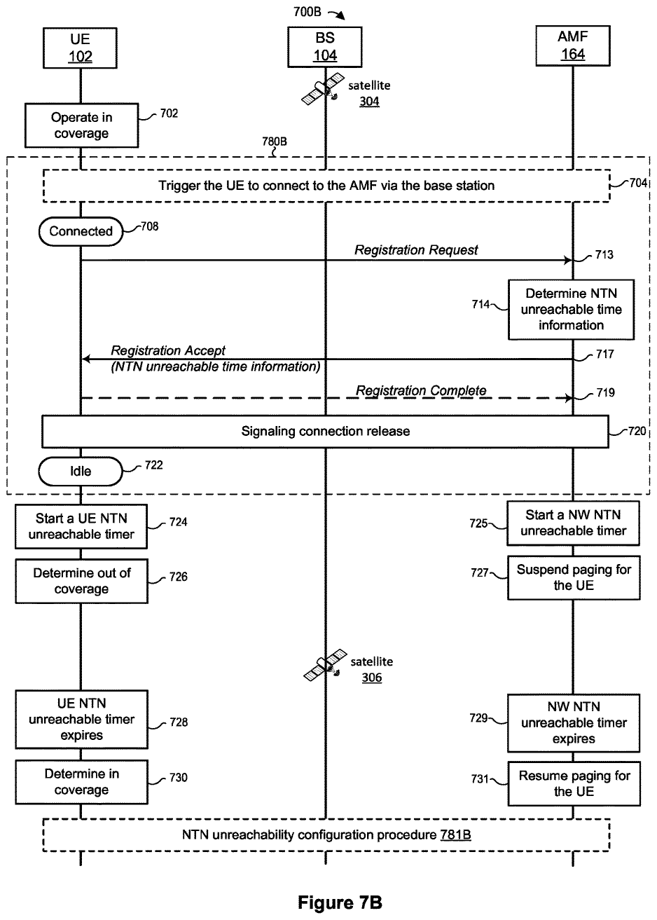

Next, FIGS. 6-7B describe several example scenarios that involve several components of FIG. 1 and relate to detecting “out of NTN coverage” while in an inactive or connected state. Generally speaking, similar events in FIGS. 6-7B are labeled with the similar reference numbers (e.g., event 602 in FIG. 6 is similar to event 702 in FIGS. 7A-7B), with differences discussed below where appropriate. With the exception of the differences shown in the figures and discussed below, any of the alternative implementations discussed with respect to a particular event (e.g., for messaging and processing) may apply to events labeled with similar reference numbers in other figures and also to both integrated and distributed base stations.

FIG. 6 illustrates an example scenario 600 in which the base station 104 of the RAN 105 includes a satellite 304 and a satellite 306. In this scenario, the UE 102 initially operates 602 in coverage (e.g., with a zone of coverage) of the satellite 304. For example, the UE 102 operating in an idle state (e.g., CM-IDLE state) is in coverage of the satellite 304 and initiates a tracking area update (TAU) procedure. In response to the initiation, the UE 102 transmits 612 a TRACKING AREA UPDATE (TAU) Request message to a component of a CN 110 (c.g., an MME 114 of the CN 110) via the base station 104 and satellite 304. After receiving 612 the TAU Request message, the MME 114 determines 614 non-terrestrial network (NTN) unreachable time information for the UE 102 and transmits 616 a TAU Accept message to the UE 102 via the base station 104 and satellite 304. Depending on the implementation, the TAU Accept message includes the NTN unreachable time information that the MME 114 determines 614 after receiving 612 the TAU Request message. In some implementations, the NTN unreachable time information indicates or includes a time period where the UE 102 may not be in coverage of a satellite of the RAN 105 (i.e., the UE 102 is out of NTN coverage). In further implementations, the UE 102 transmits 618 a TAU Complete message to the MME 114 via the base station 104 and satellite 304 in response to receiving the 616 the TAU Accept message.

In some implementations, the NTN unreachable time information includes an NTN unreachable timer value. The MME 114 (or other entity generating the NTN unreachable timer value) sets the NTN unreachable timer value based on the estimated time period between the predicted time that the UE 102 moves out of NTN coverage and the predicted time that the UE 102 comes back to NTN coverage again. In some implementations, the MME 114 generates the NTN unreachable timer value based on a predetermined margin in addition to the estimated time period (e.g., a margin of error or to give the MME 114 and/or UE 102 time to search for NTN coverage prior to the predicted time that the UE 102 comes back to NTN coverage again). For example, the MME 114 determines that the NTN unreachable timer value is smaller than the estimated time period (e.g., NTN unreachable timer value =the estimated time period-a predetermined value). The predetermined value may be a positive or negative number, which affects whether the time to search for NTN coverage occurs before or after the predicted time that the UE 102 returns to NTN coverage.

In some implementations, the MME 114 provides a periodic TAU timer value and a mobile reachable timer value in conjunction with the NTN unreachable timer value when the MME 114 transmits 616 the TAU Accept message to the UE 102. The MME 114 (or other entity) sets the periodic TAU timer value based on the estimated time period between the predicted time that the UE 102 moves out of NTN coverage and the predicted time that the UE 102 returns to NTN coverage. Similar to the NTN unreachable timer, in some implementations, the periodic TAU timer value is additionally based on a margin (e.g., a margin of error or to give the MME 114 and/or UE 102 time to search for NTN coverage after to the predicted time that the UE 102 returns to NTN coverage). For example, the MME 114 determines that the periodic TAU timer value is larger than the estimated time period (e.g., periodic TAU timer value =the estimated time period +a predetermined value). Note that the predetermined value may be a positive or negative number. The MME 114 (or other entity) similarly sets the mobile reachable timer value based on the estimated time period that the UE stays in NTN coverage. Depending on the implementation, the MME 114 similarly determines the mobile reachable timer based on a margin as described above. For example, the MME 114 determines that the mobile reachable timer value is larger than the estimated time period (e.g., mobile reachable timer value=the estimated time period+a predetermined value).

After receiving 618 the TAU Complete message or after sending 616 the TAU Accept message, the MME 114 can perform 620 a signaling connection release procedure with the UE 102 to cause the UE 102 to transition 622 to an idle state. In some implementations, the MME 114 transmits a UE Context Release message to the base station 104 to initiate the signaling connection release procedure, and the base station 104, in response, transmits ac RRC release message to the UE 102. The UE 102 transitions to the idle state in response to RRC release message. In some implementations, the idle state is a CM-IDLE state. The events 612, 616, and 618 are collectively referred to in FIG. 6 as a tracking area update procedure.

After receiving the NTN unreachable time information, the UE 102 starts 624 a UE NTN unreachable timer based on the NTN unreachable time information. In some implementations, the NTN unreachable time information includes an NTN unreachable timer value, as described above. The UE 102 starts 624 the UE NTN unreachable timer using the NTN unreachable timer value. In other implementations, the NTN unreachable time information includes a starting time and an end time. The UE 102 can determine a UE NTN unreachable timer value based on the starting time and end time. For example, the UE 102 determines the UE NTN unreachable timer value is a time period between the starting time and end time. In such a case, the UE 102 starts the UE NTN unreachable timer at the starting time based on (e.g., using) the UE NTN unreachable timer value determined by the UE 102. In further implementations, the UE 102 determines the UE NTN unreachable timer value by receiving an indication of a quantity or factor by which to increase or decrease (e.g., increase the timer by 5 seconds, decrease the timer by 2 seconds, double the timer value, etc.). In still further implementations, the UE 102 has one or more predetermined timers to reference and the NTN unreachable time information includes an indication (e.g., a flag) of which timer to use.

In some implementations, the UE 102 starts the UE NTN unreachable timer upon receiving 616 the NTN unreachable time information. In other implementations, the UE 102 starts the UE NTN unreachable timer after or in response to performing 620 the signaling connection release procedure or transitioning 622 to the idle state.

In some implementations, the UE 102 determines 626 that the UE 102 is out of NTN coverage after receiving the NTN unreachable time information and transitioning 622 to the idle state, even though the UE 102 may still be in coverage of the satellite 304. In other implementations, the UE 102 determines 626 that the UE 102 is out of NTN coverage when the UE 102 detects that the UE 102 is out of coverage of the satellite 304. In some implementations, the UE 102 starts the UE NTN unreachable timer after transitioning 622 to the idle state and detecting 626 that the UE 102 is out of coverage of the satellite 304.

While the UE NTN unreachable timer is running, the UE 102 refrains from accessing or attempting to access the NTN (i.e., the RAN 105 and/or MME 114). Thus, the UE 102 saves battery power by refraining from accessing the NTN. In some implementations, when the UE 102 starts 624 the UE NTN unreachable timer or determines 626 that the UE 102 is out of NTN coverage, the UE 102 disables one or more idle-mode tasks (also referred to herein as idle mode procedures) to refrain from accessing the RAN 105 and MME 114. Depending on the implementation, the idle-mode tasks include disabling a transceiver, halting a handover procedure, halting an RRC connection procedure, pausing measurement procedures, etc. In other implementations, when the UE 102 starts 624 the UE NTN unreachable timer or determines 626 that the UE 102 is out of NTN coverage, the UE 102 enters a low power mode (e.g., by configuring a modem to enter into a low power mode) to refrain from accessing the RAN 105 and MME 114.

After transmitting 616 the NTN unreachable time information, the MME 114 starts 625 a network NTN unreachable timer based on the NTN unreachable time information. In some implementations, the MME 114 starts the network NTN unreachable timer using the NTN unreachable timer value as described above for the UE 102. In other implementations, the MME 114 determines a network NTN unreachable timer value smaller than the UE NTN unreachable timer value (e.g., network NTN unreachable timer value=UE NTN unreachable timer value−a predetermined value) and starts the network NTN unreachable timer based on (e.g., using) the network NTN unreachable timer value. In yet other implementations, the MME 114 determines a network NTN unreachable timer value larger than the UE NTN unreachable timer value (e.g., network NTN unreachable timer value=the UE NTN unreachable timer value+a predetermined value) and starts the network NTN unreachable timer based on (e.g., using) the network NTN unreachable timer value.

In other implementations, the NTN unreachable time information includes a starting time and an end time. In such cases, the MME 114 can determine a network NTN unreachable timer value based on the starting time and end time. For example, the MME 114 determines the network NTN unreachable timer value is a time period between the starting time and end time.

In some implementations, the MME 114 starts the network NTN unreachable timer at the starting time based on the network NTN unreachable timer value. In further implementations, the MME 114 determines the network NTN unreachable timer value by modifying a predetermined timer by a determined quantity or factor (e.g., increase the timer by 5 seconds, decrease the timer by 2 seconds, double the timer value, etc.). In still further implementations, the MME 114 determines one or more predetermined timers to use. In some implementations, the MME 114 starts the network NTN unreachable timer after or in response to performing 620 the signaling connection release procedure or causing the UE 102 to transition 622 to the idle state.

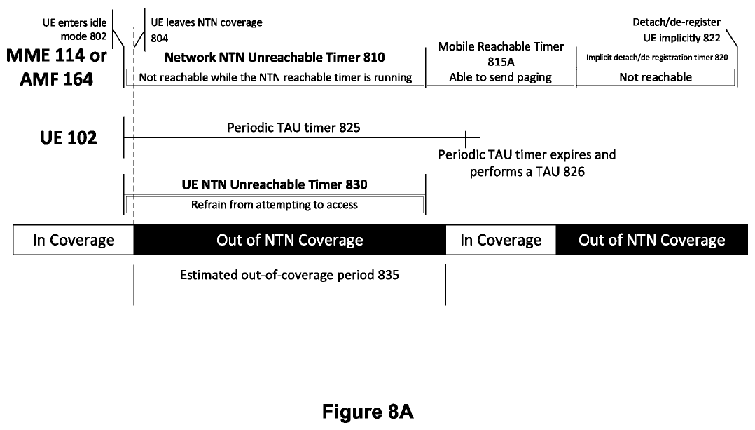

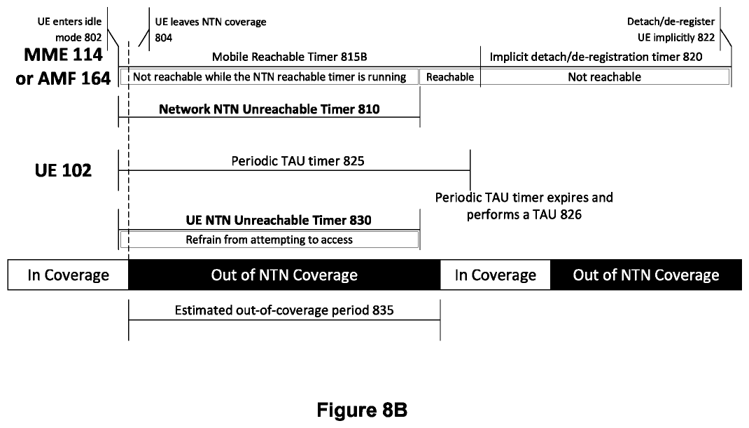

In some implementations, the MME 114 starts 625 the network NTN unreachable timer instead of a mobile reachable timer. For example, if the MME 114 previously provided the UE 102 with NTN unreachable time information, the MME 114 does not start a mobile reachable timer upon a transition to idle state or mode, but starts the network NTN unreachable timer instead. The MME 114 instead starts the mobile reachable timer upon an expiry of the network NTN unreachable timer, as described in more detail below with regard to FIG. 8A. In other implementations, the MME 114 starts the network NTN unreachable timer and the mobile reachable timer simultaneously. For example, if the MME 114 previously provided the UE 102 with the NTN unreachable time information, the MME 114 starts the mobile reachable timer and the network NTN unreachable timer upon a transition to idle state or mode. In this case, although the mobile reachable timer is running, the MME 114 considers the UE 102 as unreachable while the network NTN unreachable timer is running, as described in more detail below with regard to FIG. 8B. Upon the expiry of the network NTN unreachable timer, the MME 114 considers the UE 102 as reachable again if the mobile reachable timer is still running.

While the network NTN unreachable timer is running, the MME 114 suspends 627 (e.g., refrains from) a paging function for the UE 102. For example, if the MME 114 receives data for the UE 102 or a request for paging the UE 102 from another network node (e.g., SGW 112 or PGW 116), after suspending the paging function for the UE 102, the MME 114 refrains from transmitting an interface paging message for the UE 102 to the base station 104.

In some implementations, the UE 102 includes location information of the UE 102, indicating a location of the UE 102, in the TAU Request message. For example, the location information includes Global Navigation Satellite System (GNSS) information (e.g., longitude, latitude and/or altitude) of the UE 102. The MME 104 can determine the NTN unreachable time information based on the location information and ephemeris information of the satellite 306. For example, the ephemeris information includes position and velocity state vector or orbital parameters.

In some implementations, the MME 114 triggers 604 the UE 102 to connect to the MME 114 and/or perform the TAU procedure instead of the UE 102 initiating the TAU procedure. For example, the MME 114 transmits an interface paging message (e.g., S1 Application Protocol (S1AP) Paging message) to the base station 104 to cause the base station 104 to page the UE 102 operating in the idle state. In response to the interface paging message, the base station 104 transmits a paging message (e.g., RRC Paging message) to the UE 102 via the satellite 304. In response to the paging message, the UE 102 performs a connection establishment procedure with the base station 104 via the satellite 304 and transmits a Service Request message to the MME 114 via the base station 104 and satellite 304 to establish a signaling connection with the MME 114. In response, the MME 114 can transmit a Service Accept message to the UE 102 via the base station 104 and satellite 304. After performing the connection establishment procedure, transmitting the Service Request message, and/or receiving the Service Accept message, the UE 102 transitions 606 to a connected state (e.g., ECM-CONNECTED or EMM-CONNECTED). After receiving the Service Request message or transmitting the Service Accept message, the MME 104 transmits 608 a GUTI reallocation command message via the base station 104 and satellite 304 to the UE 102 to trigger the UE 102 to perform the tracking area update procedure. In response, the UE 102 transmits 610 a GUTI reallocation complete message to the MME 114 via the base station 104 and satellite 304 and performs the tracking area update procedure.

The events 604, 606, 608, 610, 612, 614, 616, 618, 620, and 622 are collectively referred to in FIG. 6 as an NTN unreachability configuration procedure 680.

Later in time, the UE 102 detects that the UE NTN unreachable timer expires 628. In some implementations, upon or after detecting the UE NTN unreachable timer expires, the UE 102 attempts to receive signals from a satellite (e.g., satellite 306). If the UE 102 receives broadcast, paging, or other DL signals from the satellite 306, the UE 102 determines 630 that the UE 102 is in NTN coverage. After the determination 630, the UE 102 can perform 681 an NTN unreachability configuration procedure with the MME 114, similar to the procedure 680. In the procedure 681, the MME 114 can transmit, to the UE 102, the NTN unreachable time information identical to the previous NTN unreachable time information in the procedure 680. Alternatively, in the procedure 681, the MME 114 transmits, to the UE 102, new NTN unreachable time information different from the previous NTN unreachable time information. Yet alternatively, the MME 114 does not include NTN unreachable time information in a TAU Accept message in the procedure 681. In such cases, the UE 102 refrains from starting the UE NTN unreachable timer upon receiving the TAU Accept message.

Similarly, the MME 114 detects that the network NTN unreachable timer expires 629. Upon or after detecting that the network NTN unreachable timer expires 629, the MME 114 resumes 631 the paging function for the UE 102. For example, if the MME 114 receives data for the UE 102 or a request for paging the UE 102 from another network node (e.g., SGW 112 or PGW 116), after resuming the paging function for the UE 102, the MME 114 pages the UE 102 or attempts paging the UE 102. To attempt to page the UE 102, the MME 114 transmits an interface paging message to the base station 104 to cause the base station 104 to page the UE 102, as described above.

Referring next to FIG. 7A, scenario 700A is generally similar to the scenario 600, except that an AMF 164 of the CN 110 provides information to the UE 102 rather than an MME 116 causing the UE 102 to initiate an update procedure. In particular, events with similar numbers (e.g., events 602 and 702, events 604 and 704, events 606 and 706, etc.) are performed similarly except as discussed herein. The differences between the scenarios 600 and 700A are discussed below.

The AMF 164 determines 714 NTN unreachable time information similar to the MME 116 determining 614 the NTN unreachable time information as described with regard to FIG. 6 above. As such, additional embodiments and implementations as described with regard to event 614 similarly apply to event 714. Moreover, the AMF 164 may determine 714 the NTN unreachable time information prior to triggering 704 the UE 102 to connect to the AMF 164 via the base station 104.

After the UE 102 enters the connected state (e.g., 5GCM-CONNECTED or 5GMM-CONNECTED) 706 with the AMF 164, the AMF 164 transmits 709 an update command (e.g., a Configuration Update Command message) to the UE 102 via the base station 104 and/or satellite 304. The update command includes NTN unreachable time information for the UE 102 to use in configuration and in starting 724 the UE NTN reachable timer, as described above with regard to FIG. 6. In particular, in some implementations, the NTN unreachable time information indicates or includes a time period where the UE 102 may not be in coverage of a satellite of the RAN 105 (i.e., the UE 102 is out of NTN coverage).

In some implementations, the NTN unreachable time information includes an NTN unreachable timer value. The NTN unreachable timer value is set based on the estimated time period between the time that the UE moves out of NTN coverage and the time that the UE comes back to NTN coverage again. For example, the AMF 164 determines that the NTN unreachable timer value is smaller than the estimated time period (e.g., NTN unreachable timer value =the estimated time period-a predetermined value). The predetermined value may be a positive or negative number, which affects whether the time to search for NTN coverage occurs before or after the predicted time that the UE 102 returns to NTN coverage.

After the AMF 164 transmits 709 the update command including the NTN unreachable time information, the UE 102 transmits 711 a response acknowledging that the UE receives the command for configuration (e.g., a Configuration Update Complete message). After transmitting 711 the response, the UE 102 and the AMF 164 perform 720 a signaling connection release and the UE 102 enters an idle mode 722 as described above with regard to FIG. 6.

Referring next to FIG. 7B, scenario 700B is generally similar to the scenarios 600 and/or 700A, except that the AMF 164 of the CN 110 provides information regarding an NTN unreachable time period to the UE 102 during an ongoing registration request. In particular, events with similar numbers (e.g., events 602 and 702, events 604 and 704, events 606 and 706, etc.) or identical numbers are performed similarly except as discussed herein. The differences between the scenarios 600/700A and 700B are discussed below.

After entering the connected state 706, the UE 102 transmits 713 a registration request message to the AMF 164 to register with the CN 110. Depending on the implementation, the UE 102 may include location information for the UE 102, a radio connection establishment cause, a UE identifier (e.g., a RAN UE NGAP ID), a CN identifier (e.g., an AMF Set ID), etc., in the registration request message.

The AMF 164 may then determine 714 the NTN unreachable time information as described above with regard to FIGS. 6 and/or 7A. Depending on the implementation, the AMF 164 uses information included in the registration request (e.g., user location information) and/or otherwise gathered or received by the AMF 164 (e.g., ephemeris information for the satellite 304) to determine 714 the NTN unreachable time information.

After determining 714 the NTN unreachable time information, the AMF 164 transmits 717 a message indicating that the AMF 164 accepts the registration from the UE 102 (e.g., a Registration Accept message). The AMF 164 includes the NTN unreachable information as determined 714 by the AMF 164 in the message. The NTN unreachable information includes and/or resembles the NTN unreachable information described above with regard to FIGS. 6 and/or 7A, and embodiments and implementations as described with regard to such similarly apply to FIG. 7B.

In some implementations, the UE 102 responds to receiving 717 the message by transmitting 719 a response indicating that the registration is completed. The UE 102 and the AMF 164 then perform 720 a signaling connection release and the UE 102 enters the idle mode 722.

FIGS. 8A and 8B show examples of the timers running in the CN node side and the UE 102 side respectively. For EPS, the CN node is or includes an MME 114. For 5GS, the CN node is or includes an AMF 164.

In FIG. 8A, the CN node starts a network NTN unreachable timer 810 when the UE 102 transitions 802 to an idle mode/state. Depending on the implementation, the CN 110 receives a predetermined timer value, generates a timer value (e.g., as described with regard to FIGS. 6-7B), is preconfigured with a timer value, etc. While the network NTN unreachable timer 810 is active, the CN node considers the UE 102 to be unreachable. After the network unreachable timer 810 ends, however, the CN node starts a mobile reachable timer 815A and considers the UE 102 to be reachable (e.g., the CN node is able to send paging messages to the UE 102). In some implementations, after a predetermined period of time passes without transmissions to or from the UE 102, the CN 110 begins an implicit detach/de-registration timer 820, during which the CN 110 considers the UE 102 to be unreachable unless the UE 102 resumes transmission of messages. At the end of the implicit detach/de-registration timer 820, the CN 110 detaches/de-registers 822 the UE 102 implicitly, i.e. without any signaling to the UE 102.

On the UE-side, after the UE 102 leaves 804 the NTN coverage, the UE 102 begins a periodic TAU timer 825, after the expiry of which, the UE 102 performs 826 a TAU procedure. Further, at the same time the CN node begins a network NTN unreachable timer 810 (e.g., when the UE 102 enters 802 an idle mode), the UE 102 starts a UE NTN unreachable timer 830.

Depending on the implementation, the UE 102 refrains from attempting to access the CN node while the UE NTN unreachable timer 830 is active (e.g., the UE 102 turns off radio capability) for power saving. In some implementations, the UE 102 NTN unreachable timer 830 mirrors the network NTN unreachable timer 810, which in turn matches an estimated out-of-coverage period 835 perhaps with a (positive or negative) margin of error regarding the estimation. In other implementations, the UE NTN unreachable timer 830 and/or the network unreachable timer 810 do not match each other and/or the estimated out-of-coverage period 835.

In FIG. 8B, the CN node starts the network NTN unreachable timer 810 and the mobile reachable timer 815B simultaneously when the UE 102 enters 802 the idle mode/state. In the example of FIG. 8B, although the mobile reachable timer 815B is running, the MME 114 or AMF 164 considers the UE 102 as unreachable while the network NTN unreachable timer 810 is running. In some implementations, the mobile reachable timer 815B is associated with a terrestrial network node with which the UE 102 communicates, and thus for NTN communications, the network NTN unreachable timer 810 takes priority. Upon the expiry of the network NTN unreachable timer 810, the MME 114 or AMF 164 considers the UE 102 as reachable again if the mobile reachable timer 815B is still running. Otherwise, on or after the mobile reachable timer 815B expires, the MME 114 or AMF 164 starts an implicit detach/de-registration timer 820 as described above.

Depending on the implementation, the UE NTN unreachable timer 830 may be shorter than or longer than the periodic TAU timer 825. When the UE NTN unreachable timer 830 is shorter (e.g., as depicted in FIG. 8B), then the UE 102 waits for the TAU timer to expire and performs 826 a periodic TAU procedure with the CN 110. When the UE NTN unreachable timer 830 is longer than the periodic TAU timer 825, the UE 102 does not perform 826 the periodic TAU procedure when the periodic TAU timer 825 expires because the unreachable timer has not expired. Otherwise, the UE 102 operates as described above with regard to FIG. 8A.

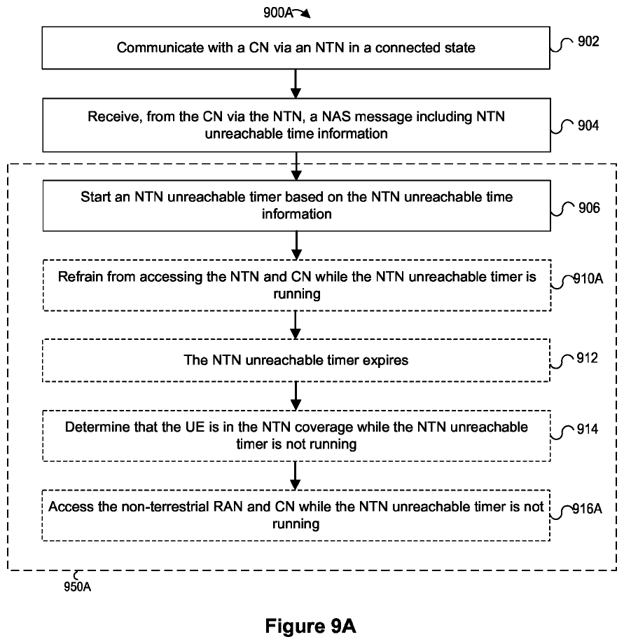

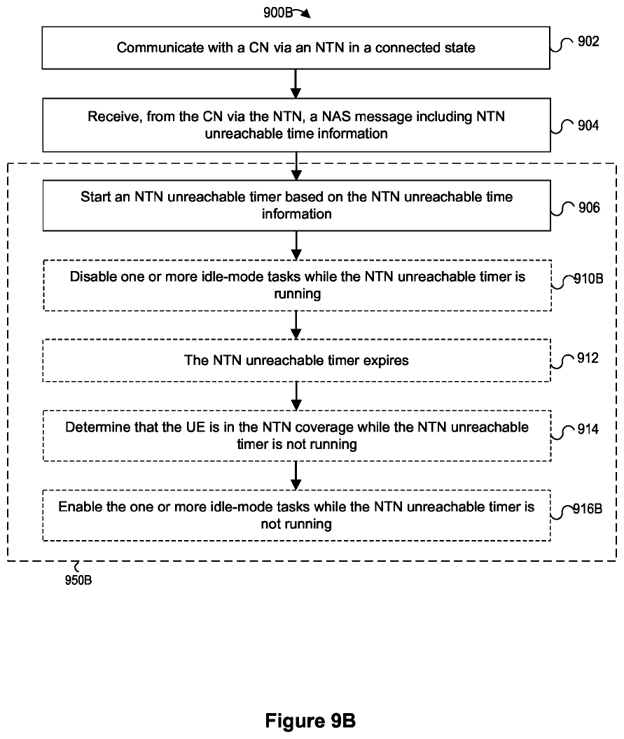

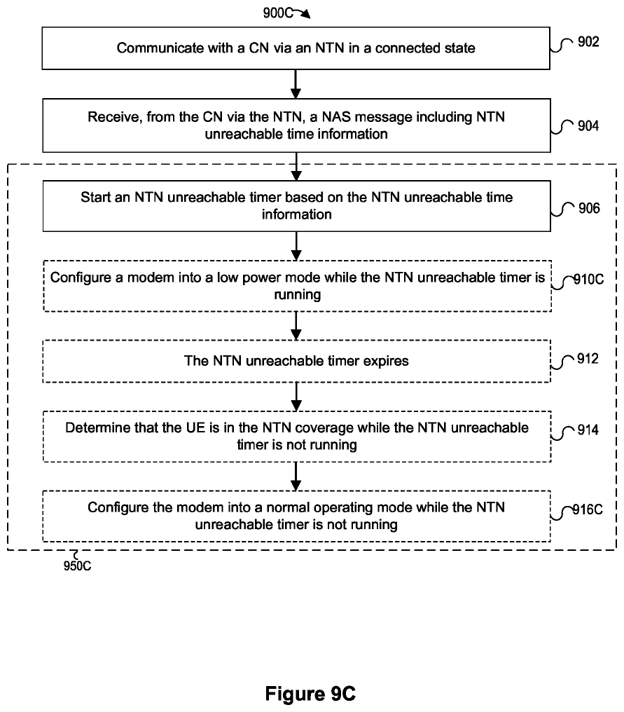

Next, several example methods that can be implemented in a UE (e.g., the UE 102) or a CN node such as an MME or an AMF are discussed with reference to FIGS. 9A-13. Each of these methods can be implemented using processing hardware such as one or more processors to execute instructions stored on a non-transitory computer-readable medium such as computer memory.

Referring first to FIG. 9A, a method 900A can be implemented in a suitable UE and includes receiving unreachable time information and starting an unreachable timer, during which the UE refrains from accessing the NTN. For clarity, the method 900A is discussed with reference to the RAN 105, base station 104, the CN 110, the UE 102, and the satellite 304.

At block 902, the UE 102 communicates with a CN 110 via an NTN node, such as satellite 304, while in a connected state (e.g., events 606, 608, 610, 612, 706, and 713 of FIGS. 6-7B). At block 904, the UE 102 receives, from the CN 110 via the NTN node, a NAS message including NTN unreachable time information (e.g., events 616, 709, and 717 of FIGS. 6-7B). In some implementations, the UE 102 transmits information that the CN 110 uses to generate the NTN unreachable time information. For example, the UE 102 can transmit location information that the CN 110 uses in determining when the UE 102 will leave coverage for the NTN. Further, depending on the implementation, the CN 110 includes the NTN unreachable time information in a tracking area message (e.g., a TAU Accept message), a configuration message (e.g., a Configuration Update Command message), a registration message (e.g., a Registration Accept message), etc.

At block 906, the UE 102 starts an NTN unreachable timer based on at least the NTN unreachable time information (e.g., events 622 and 722 of FIGS. 6-7B). In some implementations, the UE 102 starts the timer after entering an idle mode. In other implementations, the UE 102 instead starts the timer while entering the idle mode and/or immediately prior to entering the idle mode.

At block 910A, the UE 102 refrains from accessing the NTN while the NTN unreachable timer is running. In particular, the UE 102 refrains from accessing the CN 110 and a coverage cell (e.g., cell 124) via the NTN while the NTN unreachable timer is running. At block 912, the NTN unreachable timer expires (e.g., events 628 and 728 of FIGS. 6-7B) and, at block 914, the UE 102 determines that the UE 102 is inside NTN coverage when the timer is not running (e.g., events 630 and 730 of FIGS. 6-7B). In some implementations, the UE 102 determines that the UE 102 is inside of NTN coverage based on a broadcast message (e.g., a master information block (MIB) or secondary information block (SIB) broadcast message) from a cell (e.g., cell 124 or 126). In further implementations, the UE 102 does not have a capability to determine whether the UE 102 is in discontinuous coverage, and automatically makes the determination based on whether the timer is running (e.g., the UE 102 determines that the UE 102 is inside of NTN coverage because the timer ends). In still further implementations, the UE 102 does not have capability as described above and instead does not make such a determination, instead proceeding directly to block 916A to attempt to access the NTN. In particular, at block 916A, the UE 102 accesses the CN 110 via the NTN node (e.g., RAN 105) while the NTN unreachable timer is not running.

Referring next to FIG. 9B, the method 900B can be implemented in a suitable UE (e.g., UE 102) and is similar to method 900A, except for blocks 910B and 916B. In particular, at block 910B, the UE 102 disables one or more idle-mode tasks while the NTN unreachable timer is running. Similarly, at block 916B, the UE 102 enables the one or more idle-mode tasks while the NTN unreachable timer is not running. Depending on the implementation, disabling the one or more idle-mode tasks may include disabling a transceiver, halting a handover procedure, halting an RRC connection procedure, etc.

Referring next to FIG. 9C, the method 900C can be implemented in a suitable UE (e.g., UE 102) and is similar to method 900A, except for blocks 910C and 916C. In particular, at block 910C, the UE 102 enters into a low power mode while the NTN unreachable timer is running. Similarly, at block 916C, the UE 102 exits the lower power mode and enters into a normal operating mode while the NTN unreachable timer is not running. Depending on the implementation, the UE 102 enters the low power mode by causing a modem to enter into a low power mode while the NTN unreachable timer is running, and similarly enters the normal operating mode by causing the modem to exit the low power mode.

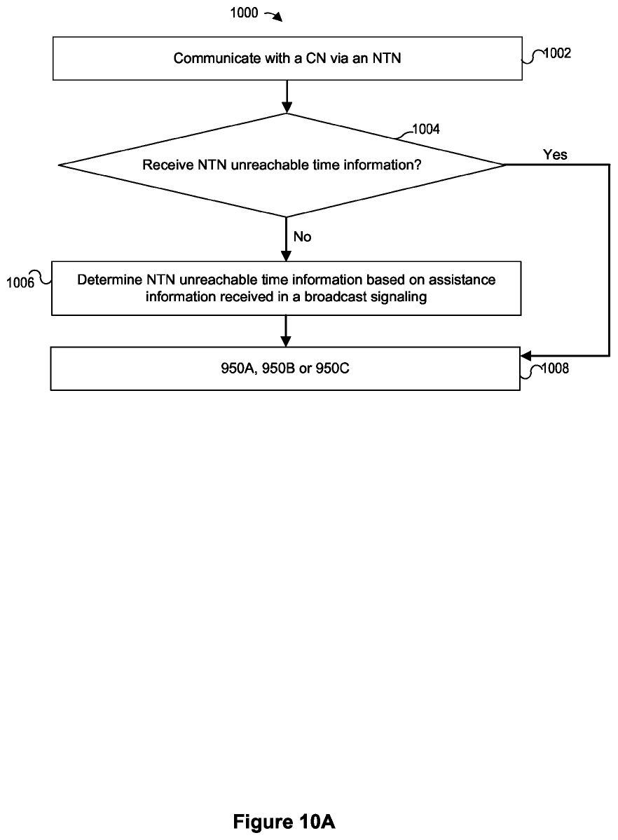

Referring next to FIG. 10, a method 1000 can be implemented in a suitable UE and includes determining unreachable time information based on information received in broadcast signaling when the UE does not receive the unreachable time information. For clarity, the method 1000 is discussed with reference to the RAN 105, base station 104, the CN 110, the UE 102, and the satellite 304.

At block 1002, the UE 102 communicates with a CN 110 via an NTN node, such as satellite 304, similar to block 902 of FIGS. 9A-9C. At block 1004, the UE 102 determines whether the UE 102 receives NTN unreachable time information. If so, then flow proceeds to block 1008. If not, flow first proceeds to block 1006 and then block 1008.

At block 1006, the UE 102 determines the NTN unreachable time information based on assistance information received in broadcast signaling (e.g., ephemeris information). In some implementations, the assistance information includes information transmit by various other NTN nodes (e.g., a second satellite 306). For example, a second satellite 306 transmits ephemeris information (e.g., an absolute satellite location, a relative constellation location, a satellite speed, a satellite trajectory, etc.) to the UE 102. Depending on the example, the second satellite can transmit the ephemeris information to the UE 102 via the initial NTN node (e.g., the satellite 304) and/or another portion of the NTN or RAN 105. In some such implementations, the UE 102 updates the CN 110 of the NTN unreachable time information as determined based on the assistance information. In other implementations, the UE 102 does not update the CN 110 (e.g., when the CN 110 makes the determination separately). Then, at block 1008, the UE 102 performs one of process 950A, process 950B, or process 950C as described with regard to FIGS. 9A-9C above.

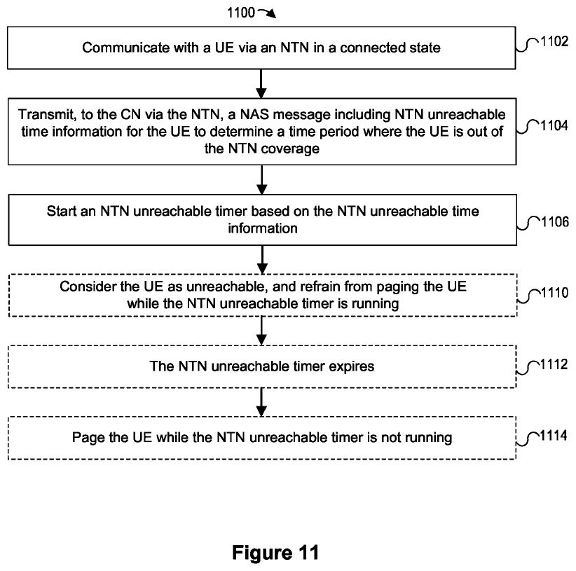

Referring next to FIG. 11, a method 1000 can be implemented in a suitable UE and includes transmitting unreachable time information to a UE, starting an unreachable timer, and refraining from paging the UE while the unreachable timer is running. For clarity, the method 1100 is discussed with reference to the RAN 105, base station 104, the CN 110, the UE 102, and the satellite 304.

At block 1102, the CN 110 communicates with a UE 102 via an NTN node, such as satellite 304, while in a connected state (e.g., events 606, 608, 610, 612, 706, and 713 of FIGS. 6A-7B). At block 1104, the CN 110 transmits, to the UE 102 and via the NTN node, a NAS message including an NTN unreachable time information for the UE 102 to determine a time period where the UE is out of NTN coverage (e.g., events 616, 709, and 717 of FIGS. 6-7B). In some implementations, the CN 110 receives information from the UE 102 that the CN 110 uses to generate the NTN unreachable time information. For example, the UE 102 can transmit location information that the CN 110 uses in determining when the UE 102 will leave coverage for the NTN. Further, depending on the implementation, the CN 110 includes the NTN unreachable time information in a tracking area message (e.g., a TAU Accept message), a configuration message (e.g., a Configuration Update Command message), a registration message (e.g., a Registration Accept message), etc.

At block 906, the UE 102 starts an NTN unreachable timer based on at least the NTN unreachable time information (e.g., events 622 and 722 of FIGS. 6-7B). In some implementations, the UE 102 starts the timer after entering an idle mode. In other implementations, the UE 102 instead starts the timer while entering the idle mode and/or immediately prior to entering the idle mode.

At block 1106, the CN 110 starts an NTN unreachable timer based on the NTN unreachable time information (e.g., events 625 and 725 of FIGS. 6-7B). In some implementations, the CN 110 starts the timer after the UE 102 enters an idle mode. In other implementations, the CN 110 instead starts the timer while the UE 102 enters the idle mode and/or before the UE 102 enters the idle mode.

At block 1110, the CN 110 refrains from paging the UE 102 while the NTN unreachable timer is running (e.g., events 627 and 727 of FIGS. 6-7B). In particular, the CN 110 considers the UE 102 as unreachable after starting the unreachable timer. Depending on the implementation, the CN 110 stores a variable and considers the UE 102 as reachable or unreachable depending on the status of the variable (e.g., a binary flag). At block 1112, the NTN unreachable timer expires (e.g., events 629 and 729 of FIGS. 6-7B). In some implementations, the CN 110 causes the NTN unreachable timer to end early. Then, at block 1114, the CN 110 pages the UE while the NTN unreachable timer is not running (e.g., events 631 and 731 of FIGS. 6-7B).

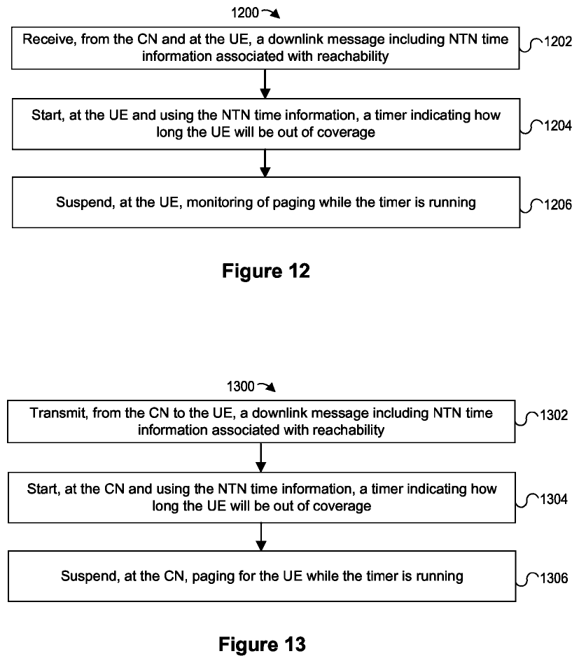

Referring next to FIG. 12, a method 1200 can be implemented in a suitable UE and includes receiving NTN time information from a CN and generating a timer for managing paging based on the received information. For clarity, the method 1200 is discussed with reference to the CN 110 and the UE 102.

At block 1202, the UE 102 receives, from the CN 110, a downlink message including NTN time information associated with reachability (e.g., events 616, 709, 717, 904, and 1004 of FIGS. 6-7B and 9A-10). At block 1204, the UE 102 starts, using the NTN time information, a timer indicating how long the UE 102 will be out of coverage (e.g., events 624, 724, 906, and 1008 of FIGS. 6-7B and 9A-10). At block 1206, the UE 102 suspends monitoring of paging (e.g., one or more paging channels) while the timer is running (e.g., events 910A, 910B, 910C, and 1008 of FIGS. 9A-10).

Referring next to FIG. 13, a method 1300 can be implemented in a suitable CN and includes transmitting NTN time information to a UE for generating a timer for managing paging. For clarity, the method 1300 is discussed with reference to the CN 110 and the UE 102.

At block 1302, the CN 110 transmits, to the UE 102, a downlink message including NTN time information associated with reachability (e.g., events 616, 709, 717, and 1104 of FIGS. 6-7B and 11). At block 1304, the CN 110 starts, using the NTN time information, a timer indicating how long the UE 102 will be out of coverage (e.g., e.g., events 625, 725, and 1106 of FIGS. 6-7B and 11). At block 1306, the CN 110 suspends paging for the UE 102 while the timer is running (e.g., events 627, 727, and 1110 of FIGS. 6-7B and 11).

The following list of examples reflects a variety of the embodiments explicitly contemplated by the present disclosure:

Example 1. A method, implemented in a user equipment (UE) communicating with a core network (CN) via a node of a non-terrestrial network (NTN), for managing paging for the UE from the CN, the method comprising: receiving, from the CN, a downlink message including NTN time information associated with reachability of the UE; starting, at the UE, a timer with a time duration based on the NTN time information; and suspending, at the UE, monitoring of paging messages for the UE while the timer is running.

Example 2. The method of example 1, the method further comprising: entering a power saving mode while the timer is running.

Example 3. The method of example 1 or 2, the method further comprising: refraining from accessing the NTN while the timer is running.

Example 4. The method of any one of the preceding examples, the method further comprising: refraining from performing an idle mode procedure while the timer is running.

Example 5. The method of example 4, wherein the refraining from performing the idle mode procedure includes: disabling a transceiver of the UE.

Example 6. The method of example 4, wherein the refraining from performing the idle mode procedure includes: discontinuing camping on a cell.

Example 7. The method of example 4, wherein the refraining from performing the idle mode procedure includes: pausing from accessing ephemeris information associated with the NTN.

Example 8. The method of example 4, wherein the node of the NTN is a first node of the NTN and the refraining from performing the idle mode procedure includes: abstaining from accessing a second node of the NTN.

Example 9. The method of any one of the preceding examples, the method further comprising: in response to the timer expiring, resuming monitoring for paging.

Example 10. The method of any one of the preceding examples, wherein the downlink message is a downlink (DL) non-access stratum (NAS) message.

Example 11. The method of example 10 wherein the DL NAS message includes a tracking area update message.

Example 12. The method of example 10, wherein the DL NAS message includes a message associated with accepting a registration of the UE to the CN.

Example 13. The method of example 10, wherein the DL NAS message includes a configuration update message.

Example 14. The method of any one of the preceding examples, wherein the NTN time information includes the time duration for the timer.

Example 15. The method of any one of examples 1-13, wherein the NTN time information includes a quantity by which to adjust a default timer value to generate the time duration for the timer.

Example 16. The method of any one of examples 1-13, wherein the NTN time information includes an indication of which of a plurality of durations the UE should use as the time duration for the timer.

Example 17. The method of example 1, wherein the timer is a first timer associated with NTN reachability, the method further comprising: in response to transitioning into an idle mode, starting a second timer that delimits a time period between subsequent tracking areas.

Example 18. The method of example 17, the method further comprising: while the first timer and the second timer are both running, refraining from accessing the NTN.

Example 19. The method of example 17, the method further comprising: while the first timer and the second timer are both running, refraining from performing an idle mode procedure.

Example 20. The method of example 17, the method further comprising: while the first timer and the second timer are both running, entering a power saving mode.

Example 21. The method of example 17, the method further comprising: while the second timer is running and the first timer is not running, monitoring for a paging message from the CN.

Example 22. The method of example 1, the method further comprising: receiving, via broadcast signaling, assistance information associated with the node of the NTN; and determining the NTN time information based on the assistance information.

Example 23. A user equipment (UE), comprising a transceiver and processing hardware, configured to implement a method according to any one of the preceding examples.

Example 24. A method, implemented in a core network (CN) communicating with a user equipment (UE) via a node of a non-terrestrial network (NTN), for managing paging for the UE, the method comprising: transmitting, from the CN to the UE, a downlink message including NTN time information associated with reachability of the UE; starting, at the CN, a timer with a timer duration based on the NTN time information; and suspending, at the CN, paging to the UE while the timer is running.

Example 25. The method of example 24, the method further comprising: in response to the timer expiring, resuming paging to the UE.

Example 26. The method of example 24, the method further comprising: receiving, from the NTN node, a NAS message including the NTN time information.

Example 27. The method of any one of examples 24-26, wherein the downlink message is a downlink (DL) non-access stratum (NAS) message.

Example 28. The method of example 27, wherein the DL NAS message includes a tracking area update message.

Example 29. The method of example 27, wherein the DL NAS message includes a message associated with accepting a registration of the UE to the CN.

Example 30. The method of example 27, wherein the DL NAS message includes a configuration update message.

Example 31. The method of example 27, wherein the timer is a first timer associated with NTN reachability, the method further comprising: in response to transitioning into an idle mode, starting a second timer associated with terrestrial reachability.

Example 32. The method of example 31, the method further comprising: wherein while the first timer and the second timer are both running, refraining from paging the UE.

Example 33. The method of 31, the method further comprising: wherein while the second timer is running and the first timer is not running, paging the UE.

Example 34. A network node, comprising a transceiver and processing hardware, configured to implement a method according to any one of examples 24-33.

Example 35. The method of any one of examples 1-22, wherein the receiving the downlink message includes: receiving, from the CN, a downlink non-access stratum (NAS) message including the NTN time information.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors. readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, implemented in a user equipment (UE) communicating with a core network (CN) via a node of a non-terrestrial network (NTN), for managing paging for the UE from the CN, the method comprising:
receiving, from the CN, a downlink message including NTN unreachable time information associated with reachability of the UE;
starting, at the UE, a timer with a time duration based on the NTN unreachable time information; and
suspending, at the UE, monitoring of paging messages for the UE while the timer is running.

2. The method of claim 1, the method further comprising:
entering a power saving mode while the timer is running.

3. The method of claim 1, wherein the receiving the downlink message includes:
receiving, from the CN, a downlink non-access stratum (NAS) message including the NTN unreachable time information.

4. The method of claim 1, the method further comprising:
refraining from performing an idle mode procedure while the timer is running.

5. The method of claim 1, wherein the NTN unreachable time information includes the time duration and a starting time for the timer.

6. The method of claim 1, wherein the NTN unreachable time information includes a quantity by which to adjust a default timer value to generate the time duration for the timer.

7. The method of claim 1, wherein the NTN unreachable time information includes an indication of which of a plurality of durations the UE should use as the time duration for the timer.

8. The method of claim 1, wherein the timer is a first timer associated with NTN reachability, the method further comprising:
in response to transitioning into an idle mode, starting a second timer that delimits a time period between subsequent tracking areas.

9. The method of claim 1, the method further comprising:
receiving, via broadcast signaling, assistance information associated with the node of the NTN; and
determining the NTN unreachable time information based on the assistance information.

10. (canceled)

11. A method, implemented in a core network (CN) communicating with a user equipment (UE) via a node of a non-terrestrial network (NTN), for managing paging for the UE, the method comprising:
transmitting, from the CN to the UE, a downlink message including NTN unreachable time information associated with reachability of the UE;
starting, at the CN, a timer with a timer duration based on the NTN unreachable time information; and
suspending, at the CN, paging to the UE while the timer is running.

12. The method of claim 11, the method further comprising:
receiving, from the NTN node, a NAS message including the NTN unreachable time information.

13. The method of claim 11, wherein the downlink message is a downlink (DL) non-access stratum (NAS) message.

14. The method of claim 13, wherein the timer is a first timer associated with NTN reachability, the method further comprising:
in response to transitioning into an idle mode, starting a second timer associated with terrestrial reachability.

15. (canceled)

16. The method of claim 1, wherein the downlink message is a registration acceptance message.

17. An apparatus functioning as a user equipment (UE) to communicate with a core network (CN) via a node of a non-terrestrial network (NTN) and to manage paging for the UE from the CN, comprising:
a transceiver; and
processing hardware configured to:
receive, from the CN, a downlink message including NTN unreachable time information associated with reachability of the UE;
start, at the UE, a timer with a time duration based on the NTN unreachable time information; and
suspend, at the UE, monitoring of paging messages for the UE while the timer is running.

18. The apparatus of claim 17, wherein the processing hardware is further configured to:
enter a power saving mode while the timer is running.

19. The apparatus of claim 17, wherein the processing hardware configured to receive the downlink message is further configured to:
receive, from the CN, a downlink non-access stratum (NAS) message including the NTN unreachable time information.

20. The apparatus of claim 17, wherein the processing hardware is further configured to:
refrain from performing an idle mode procedure while the timer is running.

21. The apparatus of claim 17, wherein the NTN unreachable time information includes the time duration and a starting time for the timer.

22. The apparatus of claim 17, wherein the downlink message is a registration acceptance message.
